(19) United States
(12) Patent Application Publication
(10) Pub. No.: US 2018/0052776 A1
(43) Pub. Date: Feb. 22, 2018

(54) Shared Virtual Index for Memory Object Fusion in Heterogeneous Cooperative Computing

(71) Applicant: QUALCOMM Incorporated, San Diego, CA (US)

(72) Inventors: Han Zhao, Santa Clara, CA (US); Arun Raman, San Francisco, CA (US); Aravind Natarajan, Sunnyvale, CA (US)

(21) Appl. No.: 15/239,937

(22) Filed: Aug. 18, 2016

(51) Int. Cl. G06F 12/109

(52) U.S. Cl. CPC G06F 12/109; G06F 2212/657; G06F 2212/1041

(57) ABSTRACT

Embodiments include computing devices, apparatus, and methods implemented by the apparatus for implementing shared virtual index translation on a computing device. The computing device may receive a base virtual address for storing an output of a kernel function execution to a dedicated memory and determine whether the virtual address is in a range of virtual addresses for a privatized output buffer within the dedicated memory, which may be smaller than the dedicated memory. The computing device may calculate a first modified physical address using a physical address mapped to the base virtual address and an offset of a first processing device associated with the dedicated memory in response to determining that the base virtual address is in the range of virtual addresses. The computing device may store the output of the kernel function execution to the privatized output buffer at the first modified physical address.

### BACKGROUND

One of the biggest challenges in heterogeneous computing is sharing data among heterogeneous processing devices, such as a central processing unit (CPU) and various kinds of accelerators. A common pattern in heterogeneous computing allows heterogeneous processing devices to work on the same data structure represented by logically contiguous memory addresses. In other words, the same kernel function is shared by many heterogeneous processing devices.

Sharing data in heterogeneous architectures using a common memory suffers from communication bus contention and low power and performance efficiency. Sharing data in heterogeneous architectures in which each processing device has its own dedicated memory results in complex data management and wasted dedicated memory space. This is because, when the same kernel function is executed by different processing devices, each of the processing devices has to allocate and maintain a logically contiguous memory space with the full size of the output to respect the computation operations expressed by the kernel function. As a result, although each processing device only works on a portion of the logically contiguous memory space, each processing device has to allocate and maintain the complete memory space. A write operation on an otherwise partially allocated write buffer would produce out-of-range errors. Such a practice wastes memory space resources, which is a problem for many accelerators in which memory is a scarce resource.

### SUMMARY

The methods and apparatuses of various embodiments provide apparatuses and methods for implementing shared virtual index translation on a computing device. The various embodiments may include receiving a base virtual address for storing an output of a kernel function execution to a dedicated memory. Some embodiments may include determining whether the virtual address is in a range of virtual addresses for a privatized output buffer within the dedicated memory, and calculating a first modified physical address using a physical address mapped to the base virtual address and an offset of a first processing device associated with the dedicated memory in response to determining that the base virtual address is in the range of virtual addresses. Some embodiments may include storing the output of the kernel function execution to the privatized output buffer at the first modified physical address.

In some embodiments, calculating a first modified physical address using a physical address mapped to the base virtual address and an offset of a first processing device associated with the dedicated memory may include subtracting the offset from the physical address.

In some embodiments, storing the output of the kernel function execution to the privatized output buffer at the first modified physical address may include storing a first portion of the output of the kernel function execution to the privatized output buffer at the first modified physical address. Some embodiments may include calculating a second modified physical address using the physical address mapped to the base virtual address, an index used in executing the kernel function, and a stride value of the kernel function. Some embodiments may include storing a second portion of the output of the kernel function execution to the privatized output buffer at the second modified physical address.

In some embodiments, calculating a second modified physical address using the physical address mapped to the base virtual address, an index used in executing the kernel function, and a stride value of the kernel function may include adding a result of a modulo operation of the index and the stride value to the physical address.

In some embodiments, the dedicated memory may be dedicated for use by the first processing device. Some embodiments may include creating the privatized output buffer in the dedicated memory. The privatized output buffer may be a portion of the dedicated memory. Some embodiments may include executing, by the first processing device, the kernel function for a first portion of an input data using a shared virtual index that is the same as the shared virtual index used by a second processing device executing the kernel function for a second portion of the input data.

Some embodiments may include storing shared virtual index information for the first processing device and the kernel function. In some embodiments the shared virtual index information may include the range of virtual addresses for the privatized output buffer and the offset of the first processing device. Some embodiments may include receiving an instruction to store the output of the kernel function execution at the base virtual address.

Some embodiments may include storing the output of the kernel function execution to the dedicated memory outside of the privatized output buffer at the physical address mapped to the base virtual address in response to determining that the base virtual address is outside of the range of virtual addresses.

Various embodiments may include a computing device including a shared virtual index translation unit for implementing shared virtual index translation, a dedicated memory, and at least one processing device. The shared virtual index translation unit and the at least one processing device may be configured to perform operations of one or more of the embodiment methods summarized above.

Various embodiments may include a computing device for implementing shared virtual index translation having means for performing functions of one or more of the embodiment methods summarized above.

Various embodiments may include a non-transitory processor-readable storage medium having stored thereon processor-executable instructions configured to cause at least one processor of a computing device to perform operations of one or more of the embodiment methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing an embodiment.

FIG. 2 is a component block diagram illustrating an example multi-core processor suitable for implementing an embodiment.

FIGS. 3A and 3B are component block diagrams illustrating examples of a shared virtual index system according to various embodiments.

FIGS. 4A-4C are block diagrams illustrating examples of memory allocation for a shared virtual index system according to various embodiments.

FIG. 5 is a component block diagram illustrating a shared virtual index translation unit according to various embodiments.

FIG. 6 is a process flow diagram illustrating shared virtual index translation according to various embodiments.

FIG. 7 is a process flow diagram illustrating shared virtual index translation according to various embodiments.

FIG. 8 is component block diagram illustrating an example mobile computing device suitable for use with the various embodiments.

FIG. 9 is component block diagram illustrating an example mobile computing device suitable for use with the various embodiments.

FIG. 10 is component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

Various embodiments include methods, and systems and devices implementing such methods for implementing a shared virtual index by a shared virtual index translation unit. In the various embodiments the shared virtual index translation unit allows each processing device executing a kernel function on a contiguous memory space to allocate an amount of dedicated memory space that the processing device needs to work on, which may be less than the total contiguous memory space used across all of the processing devices. Shared virtual address translation may be implemented across processing devices and may ensure memory operations on logical/virtual addresses are “in-bound” even though an actual allocated physical memory space may have decreased in size. The apparatus and methods may include a shared virtual index translation unit configured to calculate a shared virtual index value for use by each processing device in executing the kernel function, allowing each processing device to buffer the segment of the contiguous memory space assigned to the processing device for executing the kernel function.

In general, input data is provided to multiple heterogeneous processing devices. The input data may be allocated and maintained in one place visible to all heterogeneous processing devices. The input data may be allocated in a shared memory (e.g., Ion) buffer shared by the heterogeneous processing devices. Since input data is read-only, accessing input data incurs low overhead and is not the focus of this invention. The processing devices may use virtual addressing to access the dedicated memories to execute functions, such as a kernel function, for the input data. The virtual addresses may be translated from a logical address used by the kernel function to retrieve data upon which to execute the kernel function. The virtual addresses may be mapped to physical memory locations in the dedicated memories. The processing devices may execute a kernel function on an allocated segment of the data input and buffer the output in the dedicated memories. A final output may be created by merging the individual outputs of the processing devices.

To implement a shared virtual index, a privatized output buffer for the output data may be checked to determine whether the shared virtual index is needed before creating and/or allocating the privatized output buffer. When the shared virtual index is needed, a shared virtual index translation unit may be initialized. The shared virtual index translation unit may be initialized by storing metadata for the shared virtual index translation to a shared virtual index translation table. In a centralized implementation, a single shared virtual index translation unit may communicate with all of the processing devices. In a distributed implementation, multiple shared virtual index translation units may communicate with one or more, but less than all, of the processing devices. The shared virtual index translation unit may be implemented in hardware, software, firmware, or a combination thereof.

The shared virtual index translation table may be implemented in various forms. Each row of the shared virtual index translation table may be representative of a processing device. The shared virtual index translation table may be filled with a beginning virtual address and an ending virtual address for the allocated segment of the data input for each processing device. The shared virtual index translation table may also be filled with an offset for each processing device provided by the respective processing device. The shared virtual index translation table may be optionally filled with a stride value provided by the kernel for kernel functions that are executed using non-contiguous segments of the input data. The shared virtual index translation table may include multiple rows for a processing device associated with multiple outstanding kernels. The shared virtual index translation table may be optionally filled with kernel identifiers for correlating shared virtual index translation data sets of processing devices with multiple outstanding kernels for which the outputs for multiple kernels may be written to the same output buffer by a processing device.

For shared virtual index assisted kernel functions, the shared virtual index translation unit may implement a shared virtual index translation table lookup using a base virtual address of the output data to be stored to the dedicated memory of a processing device. The shared virtual index translation unit, using a range comparator (e.g., implemented in hardware), may compare the base virtual address with the beginning virtual address and the ending virtual address of the privatized output buffer associated with the processing device. When the base virtual address is outside the range of the beginning virtual address and the ending virtual address, the base virtual address may be converted to a base physical address using the virtual address to physical address mapping calculation of a translation lookaside buffer and the output data associated with the base physical address may be stored to the dedicated memory.

A privatized output buffer may be an allocated portion of a larger whole output buffer. Thus, when the base virtual address is in the range of the beginning virtual address and the ending virtual address, the base virtual address may be modified to reflect this shrunken allocation of an operating range for virtual addresses referred in the kernel.

The base virtual address may be modified using the offset and/or stride associated with the processing device in the shared virtual index translation table passed to a physical address generator (e.g., implemented in hardware) by a parameter gate (e.g., multiplexer which may be implemented in hardware). To modify the base virtual address, the base virtual address may be converted to a base physical address using a virtual address to physical address mapping calculation by the translation lookaside buffer. The physical address generator may modify the base physical address using the offset and/or stride value to derive a new base physical address of the privatized output buffer. The physical address generator may subtract the offset from the base physical address (i.e., new base physical address=base physical address−offset). The output data associated with the new base physical address may be stored to the dedicated memory.

In some implementations having a stride value, the stride may be ignored (e.g., not stored in the shared virtual index translation table or not passed to the physical address generator) and unused locations of the privatized output buffer would be skipped over based on computations expressed by the kernel. Using the stride value to calculate the new base physical address is optional. Only a fraction of kernels work on non-contiguous memory space and adding the stride value to address translation adds 100% more operations (with the benefit of saving additional spaces in each processing device's dedicated memory).

In some implementations having a stride value, modifying successive physical addresses to the new base physical address may include the physical address generator adding the new base physical address and a result of the shared virtual index modulo stride value (i.e., new physical address=new base physical address+shared virtual index % stride value).

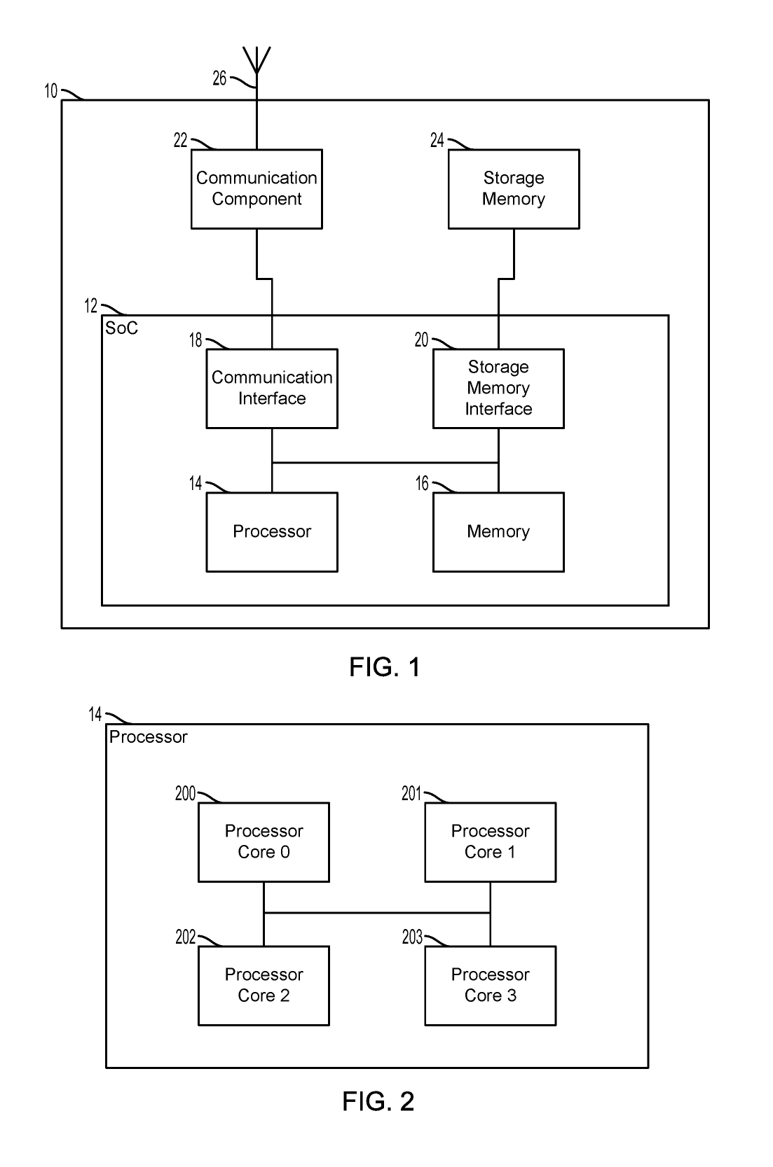

FIG. 1 illustrates a system including a computing device 10 in communication with a remote computing device (not shown) suitable for use with the various embodiments. The computing device 10 may include a system-on-chip (SoC) 12 with a processor 14, a memory 16, a communication interface 18, and a storage memory interface 20. The computing device 10 may further include a communication component 22 such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), an auxiliary processor, a single-core processor, and a multi-core processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, for access by one or more of the processors 14. The data and processor-executable code may be loaded to the memory 16 from another memory device, such as another memory 16 or storage memory 24. The data or processor-executable code loaded to the memory 16 may be loaded in response to execution of a function by the processor 14. Loading the data or processor-executable code to the memory 16 may result from a memory access request to the memory 16 that is unsuccessful (referred to as a “miss”) because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an embodiment. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. The heterogeneity of such heterogeneous processor cores may include different instruction set architectures, different pipelines, different operating frequencies, etc. An example of such heterogeneous processor cores may include what are known as “big.LITTLE” architectures in which slower, low-power processor cores may be coupled with more powerful and power-hungry processor cores. In similar embodiments, the SoC 12 may include a number of homogeneous or heterogeneous processors 14.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various embodiments to a four-core processor system. The computing device 10, the SoC 12, or the multi-core processor 14 may individually or in combination include fewer or more than the four processor cores 200, 201, 202, 203 illustrated and described herein.

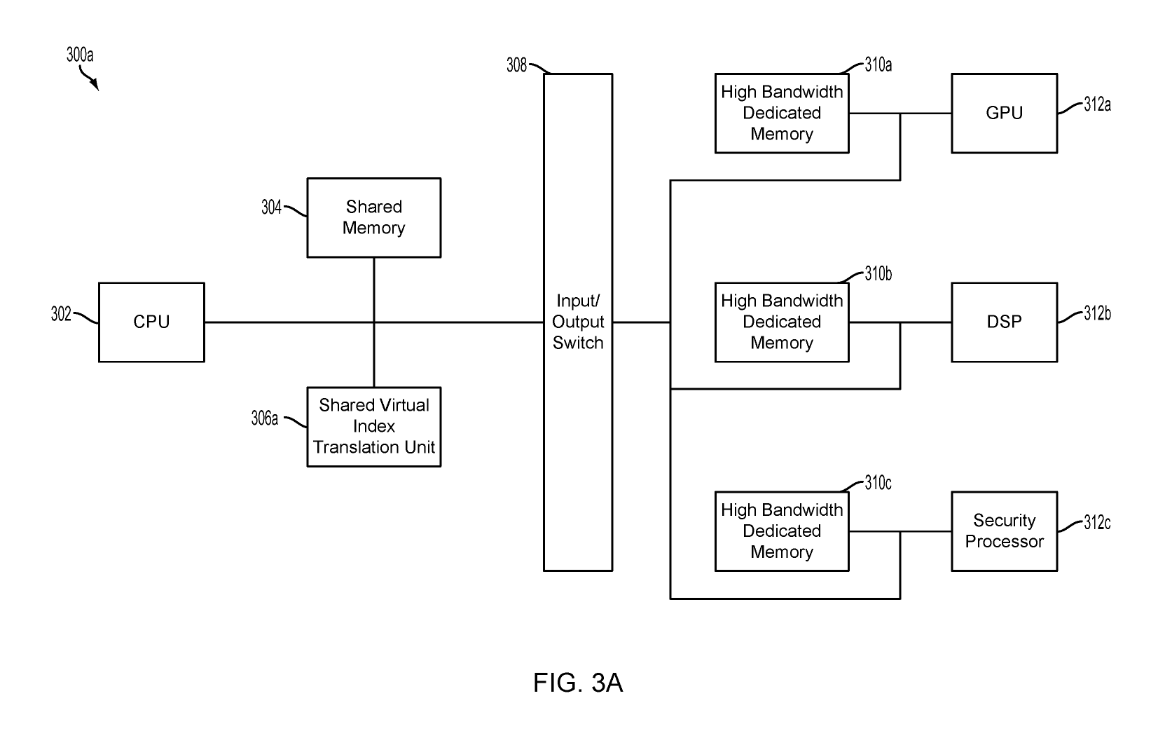

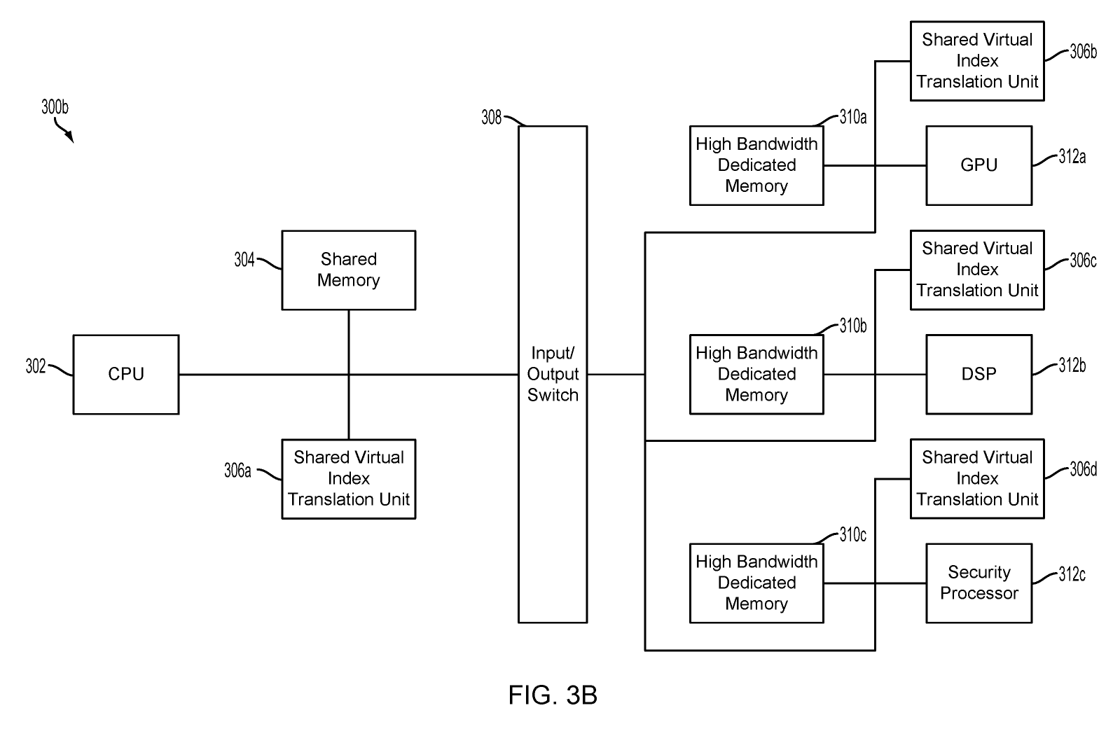

FIGS. 3A and 3B illustrate example embodiments of a shared virtual index system 300a, 300b. The shared virtual index system 300a, 300b may include a CPU 302 (e.g., processor 14 in FIGS. 1 and 2) and a shared memory 304 (e.g., memory 16, 24, in FIGS. 1 and 2). The shared virtual index system 300a, 300b may include any number of processors and/or accelerators (e.g., processor 14 in FIGS. 1 and 2). In this specification, the terms processor and accelerator may be used interchangeably as accelerators are a type of processor. Examples of processors that may function as accelerators include a GPU 312a, a DSP 312b, and a security processor 312c. Each of the various processors and accelerators 312a, 312b, 312c, may be associated with a high bandwidth dedicated memory (e.g., memory 16 in FIGS. 1 and 2). For example, the GPU 312a may be associated with a high bandwidth dedicated memory 310a, the DSP 312b may be associated with a high bandwidth dedicated memory 310b, and the security processor 312c may be associated with a high bandwidth dedicated memory 310c.

In various embodiments, the shared virtual index system 300a, 300b may include a shared virtual index translation unit 306a, or any combination of multiple shared virtual index translation units 306a, 306b, 306c, 306d, etc. as described further herein. The shared virtual index system 300a, 300b may include an input/output switch 308, such as a peripheral component interconnect express (PCIe) switch. The input/output switch 308 may be configured to transmit communications between components on either side of the input/output switch 308.

In general, an application input data operated on using a single kernel function across multiple of the CPU 302 and/or the accelerators 312a, 312b, 312c may require that the input data be stored by the shared memory 304 and/or the dedicated memories 310a, 310b, 310c, of the CPU 302 and/or the accelerators 312a, 312b, 312c executing the kernel function. An output of the kernel function executed by the CPU 302 and/or the accelerators 312a, 312b, 312c, may be output to an associated privatized output buffer (not shown) of each of the CPU 302 and/or the accelerators 312a, 312b, 312c. Privatized output buffers are buffers dedicated for use by a particular processor or accelerator. The privatized output buffers may be designated portions of the shared memory 304 and/or the dedicated memories 310a, 310b, 310c. The privatized output buffers may be designated portions of larger whole output buffers (not shown) that may include all or part of the shared memory 304 and/or the dedicated memories 310a, 310b, 310c. The kernel function may be executed using different portions of the input data by the CPU 302 and/or the accelerators 312a, 312b, 312c. To output the results of the execution of the kernel function for different portions of the input data by the CPU 302 and/or the accelerators 312a, 312b, 312c, the index used by the kernel function may need to be modified to output the results to correct locations of the privatized output buffers. Otherwise, the entire output buffers may need to be allocated to store the results of the execution of the kernel for just a portion of the input data.

In various embodiments, the shared virtual index system 300a may be a centralized shared virtual index system 300a. The centralized shared virtual index system 300a may include the shared virtual index translation unit 306a configured to communicate with any combination of the CPU 302, the shared memory 304, the accelerators 312a, 312b, 312c, and/or the dedicated memories 310a, 310b, 310c. The shared virtual index translation unit 306a may be configured to store shared virtual index information for each of the CPU 302 and/or the accelerators 312a, 312b, 312c to which the shared virtual index translation unit 306a may be connected. In various embodiments, the shared virtual index translation unit 306a may also store the shared virtual index information for each outstanding kernel function executed by the CPU 302 and/or the accelerators 312a, 312b, 312c. The shared virtual index information may include a range of virtual addresses in which an output for a kernel function operating on a portion of application input data may be stored in a privatized output buffer. The shared virtual index information also may include an offset for the virtual addresses and/or a stride for the virtual addresses at which the output of the kernel function may be stored in the privatized output buffer. In various embodiments, the shared virtual index information also may include a kernel identifier (ID) to be able to correlate specific shared virtual index information with an outstanding kernel function.

The shared virtual index translation unit 306a may also use the shared virtual index information to translate virtual addresses to modified physical addresses for storing portions of output of the kernel function execution to allocated portions of the privatized output buffers in the shared memory 304 and/or the dedicated memories 310a, 310b, 310c. The translation of the virtual addresses to the modified physical addresses may allow for allocating less than all of the shared memory 304 and/or the dedicated memories 310a, 310b, 310c for privatized output buffers configured for storing the output of the kernel function. Storage of the output of the kernel function at the modified physical addresses may allow a kernel function to use a shared virtual index for storing the output of the kernel function stored in the privatized output buffers of each of the shared memory 304 and/or the dedicated memories 310a, 310b, 310c without needing to modify the index or allocating whole buffers in each of the shared memory 304 and/or the dedicated memories 310a, 310b, 310c.

Calculation of the modified physical address may include calculating a new base physical address for storing the output of the kernel function in a privatized output buffer of the shared memory 304 and/or the dedicated memories 310a, 310b, 310c. The shared virtual index may be used by the kernel function to indicate areas of the shared memory 304 and/or the dedicated memories 310a, 310b, 310c to which to store the output of the kernel function. The shared virtual index may point to the new base physical address for each of the outputs of the kernel functions stored in the privatized output buffers of the shared memory 304 and/or the dedicated memories 310a, 310b, 310c. The shared virtual index may be the same for each execution of the kernel function. The mapping for the output of the kernel function to the shared memory 304 and/or the dedicated memories 310a, 310b, 310c may change to correspond with the shared virtual index.

The shared virtual index translation unit 306a may calculate the new base physical address for privatized output buffers of the shared memory 304 and/or the dedicated memories 310a, 310b, 310c. The shared virtual index translation unit 306a may output the new base physical address to the CPU 302 and/or the accelerators 312a, 312b, 312c, or a centralized memory manager (not shown) or distributed memory managers (not shown) for use as the physical location to store the outputs of the kernel function executions. The outputs of the kernel function executions may be stored on allocated areas of the shared memory 304 and/or the dedicated memories 310a, 310b, 310c at a new base physical address calculated for the shared memory 304 and/or the dedicated memories 310a, 310b, 310c. The CPU 302 and/or the accelerators 312a, 312b, 312c may execute the kernel function using the shared virtual index to store the output of the kernel function at the allocated privatized output buffers of their respective shared memory 304 and/or dedicated memories 310a, 310b, 310c. The results of the execution may be output from the privatized output buffers and combined to produce a final output of the execution of the kernel function on the entire input data.

In various embodiments, the shared virtual index system 300b may be a distributed shared virtual index system 300b having multiple shared virtual index translation units 306b, 306c, 306d, etc. Each of the multiple shared virtual index translation units 306b, 306c, 306d may be configured to communicate with one of the CPU 302 and/or the shared memory 304, and/or the accelerators 312a, 312b, 312c, and/or the dedicated memories 310a, 310b, 310c. In other words, a shared virtual index translation unit 306b, 306c, 306d may be configured to communicate with a single processing device/accelerator 302, 312a, 312b, 312c, and/or memory 304, 310a, 310b, 310c. The shared virtual index translation units 306b, 306c, 306d in the distributed shared virtual index system 300b may differ from the shared virtual index translation units 306a in the centralized shared virtual index system 300a by the number of components with which they communicate. Otherwise, the shared virtual index translation units 306b, 306c, 306d in the distributed shared virtual index system 300b may be configured in a manner similar to the shared virtual index translation units 306a in the centralized shared virtual index system 300a. Each of the shared virtual index translation units 306a, 306b, 306c, 306d may be configured to store shared virtual index information of their respective CPU 302 and/or accelerator 312a, 312b, 312c. In various embodiments, the shared virtual index translation units 306b, 306c, 306d may also store the shared virtual index information for each outstanding kernel function executed by their respective CPU 302 and/or accelerator 312a, 312b, 312c.

The shared virtual index translation units 306b, 306c, 306d may also use the shared virtual index information to translate virtual addresses to modified physical addresses for storing outputs of the kernel function to allocated privatized output buffers of their respective shared memory 304 and/or dedicated memory 310a, 310b, 310c. The shared virtual index translation units 306b, 306c, 306d may calculate the new base physical address for allocated privatized output buffers of the input data for their respective shared memory 304 and/or the dedicated memory 310a, 310b, 310c. The shared virtual index translation units 306b, 306c, 306d may output the new base physical address to their respective CPU 302 and/or accelerator 312a, 312b, 312c, to centralized memory managers (not shown) or to distributed memory managers (not shown). The new base physical address may be used as the physical location to store outputs of the kernel function in the allocated privatized output buffers. The CPU 302 and/or the accelerators 312a, 312b, 312c may execute the kernel function using the shared virtual index to store the outputs of the kernel function to the allocated privatized output buffers on their respective shared memory 304 and/or dedicated memories 310a, 310b, 310c. The results of the execution may be output from the privatized output buffers and combined to produce a final output of the execution of the kernel function on the entire input data.

Each of the components of the shared virtual index system 300a, 300b may be communicatively connected to any single or combination of the other components of the shared virtual index system 300a, 300b. In various embodiments, some or all of the components of the shared virtual index system 300a, 300b may be integrated components of an SoC (e.g., SoC 12 in FIG. 1). In various embodiment a combination of a centralized shared virtual index system 300a and a distributed shared virtual index system 300b may be implemented including a combination of centralized and distributed shared virtual index translation units 306a, 306b, 306c, 306d.

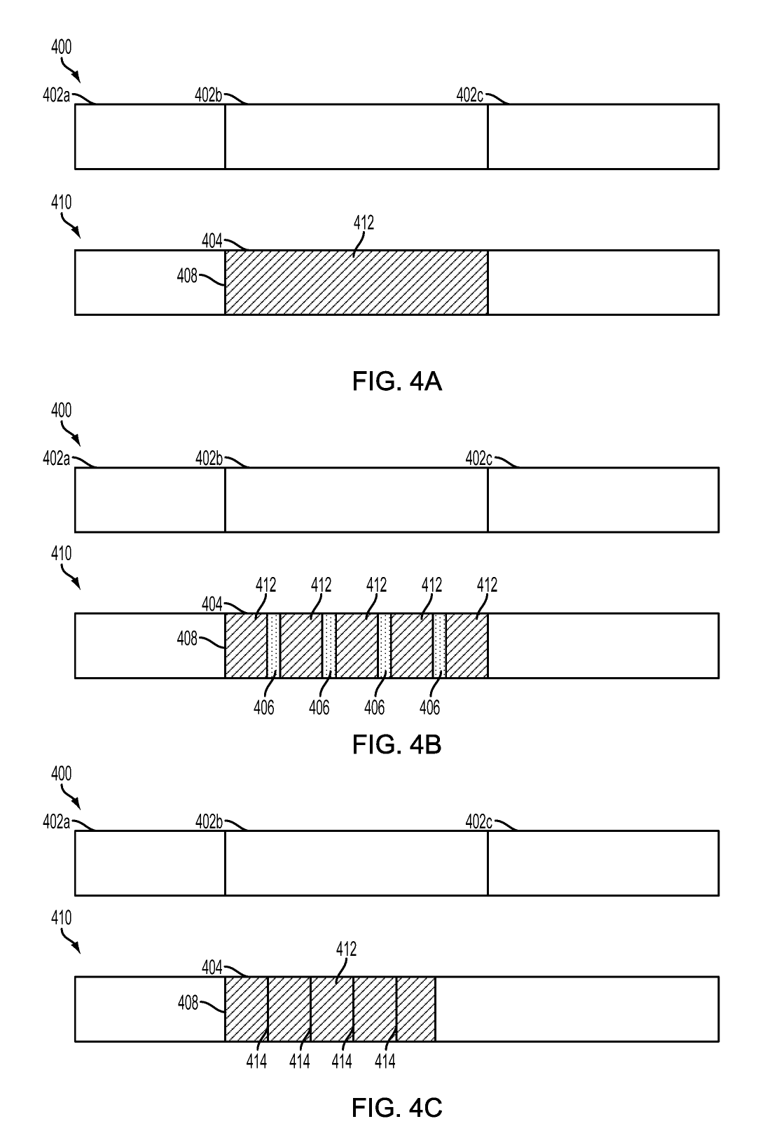

FIGS. 4A-4C illustrate examples of memory allocation for a shared virtual index system (e.g., shared virtual index system 300a, 300b in FIGS. 3A and 3B) according to various embodiments. An input data 400 may be received by the shared virtual index system. Various portions of the input data 402a, 402b, 402c may be allocated for execution by a processing device (e.g., processor 14 in FIGS. 1 and 2, and CPU 302 and accelerator 312a, 312b, 312c in FIGS. 3A and 3B) for storage on a memory 410 (e.g., memory 16, 24 in FIGS. 1 and 2, and shared memory 304 and/or dedicated memory 310a, 310b, 310c in FIGS. 3A and 3B). FIGS. 4A-4C illustrate different examples of allocating a portion of the memory as a privatized output buffer 404 when using the shared virtual index mechanism, and storing the output 412 of executing a kernel function using the shared virtual index for the portion of input data 402b to the privatized output buffer 404. Other memories (not shown) may be used for storing the output of executing the kernel function using the shared virtual index for portions of the input data 402a, 402c to privatized output buffers of the memories for use with a shared virtual index in similar manners.

FIG. 4A illustrates an example of allocating the privatized output buffer 404 for storing the output 412 of an execution of the kernel function using the shared virtual index without using a stride value for the portion of input data 402b. The processing device associated with the memory 410 may have an associated offset. The privatized output buffer 404 may be allocated in the memory 410, and may be associated with a range of virtual addresses mapped to a range of physical addresses for the privatized output buffer 404 in the memory 410. The privatized output buffer 404 may be allocated in response to a determination that the memory 410 and processing device are part of a shared virtual index system.

A shared virtual index unit (e.g., shared virtual index unit 306a, 306b, 306c, 306d in FIGS. 3A and 3B) may calculate a modified physical address for storing the output 412 of the execution of a kernel function using a shared virtual index to the privatized output buffer 404. The modified physical address may be calculated by subtracting an offset for the processing device from the base physical address for storing the output 412 to the memory 410 (i.e., new base physical address=base physical address−offset).

As described further herein, the shared virtual index unit may receive a base virtual address of the memory 410 associated with the shared virtual index for storing the output 412. The shared virtual index unit may determine whether the base virtual address is within a range of virtual addresses for the privatized output buffer 404. In response to determining that the base virtual address is within the range of virtual addresses for the privatized output buffer 404, the shared virtual index unit may use the base physical address, translated from the base virtual address, and modify the base physical address with the offset to obtain the new base physical address 408. The output 412 of an execution of the kernel function may be stored to the privatized output buffer 404 at the new base physical address 408 instead of the base physical address of the memory 410.

FIG. 4B illustrates an example of allocating the privatized output buffer 404 for storing the output 412 of an execution of the kernel function using the shared virtual index with a stride value for the portion of input data 402b. The processing device associated with the memory 410 may have an associated offset and the kernel function may have an associated stride value. The privatized output buffer 404 may be similarly configured and allocated in the memory 410 as described with reference to FIG. 4A.

A shared virtual index unit (e.g., shared virtual index units 306a, 306b, 306c, 306d in FIGS. 3A and 3B) may calculate a modified physical address for storing the output 412 of the execution of a kernel function using a shared virtual index to the privatized output buffer 404. The modified physical address may be calculated by subtracting an offset for the processing device from the base physical address for storing the output 412 to the memory 410 (i.e., new base physical address=base physical address−offset). In various embodiments, the stride value may be ignored in the allocation of the privatized output buffer 404 and the calculation of the new base physical address 408. Obtaining the new base physical address 408 for execution of a kernel with a stride value using the shared virtual index may be accomplished in a manner similar to that described with reference to FIG. 4A when the stride value is ignored.

The output 412 of an execution of the kernel function may be stored to the privatized output buffer 404 at the new base physical address 408 instead of the base physical address of the memory 410. Because of the stride value, the output 412 of the execution of the kernel function may not be contiguous as the kernel function may execute for noncontiguous portions of the portion of input data 402b because of the stride value. As a result, unused portions 406 of the allocated privatized output buffer may be interspersed with the output 412.

FIG. 4C illustrates an example of allocating the privatized output buffer 404 for storing the output 412 of an execution of the kernel function using the shared virtual index with a stride value for the portion of input data 402b. The processing device associated with the memory 410 may have an associated offset and the kernel function may have an associated stride value. The privatized output buffer 404 may be configured and allocated in the memory 410 in a manner similar to that described herein with reference to FIG. 4A. However, in various embodiments in which the stride value is used, the allocated privatized output buffer 404 may be smaller because the stride value may be accounted for, and the memory space may be compacted to eliminate the unused portions 406 of FIG. 4B. As a result, the ranges of virtual addresses and physical addressed for the privatized output buffer 404 may be smaller as well.

A shared virtual index unit (e.g., shared virtual index units 306a, 306b, 306c, 306d in FIGS. 3A and 3B) may calculate a modified physical address for storing the output 412 of the execution of a kernel function using a shared virtual index to the privatized output buffer 404. The modified physical address may be calculated by subtracting an offset for the processing device from the base physical address for storing the output 412 to the memory 410 (i.e., new base physical address=base physical address−offset). In various embodiments, the stride value may be ignored in the allocation of the privatized output buffer 404 and the calculation of the new base physical address 408. Obtaining the new base physical address 408 for an execution of a kernel with a stride value using the shared virtual index may be accomplished in a manner similar to that described with reference to FIG. 4A when the stride value is ignored. The output 412 of an execution of the kernel function may be stored to the privatized output buffer 404 at the new base physical address 408 instead of the base physical address of the memory 410.

Rather than ignoring the stride value for storing all of the output 412 to the privatized output buffer 404 as in FIG. 4B, successive modified physical addresses may be calculated to eliminate unused space created by the execution of the kernel function for noncontiguous portions of the portion of input data 402b because of the stride value. The modified physical addresses may be calculated by adding the new base physical address 408 to the shared virtual index modulo the stride value (i.e., new physical address=new base physical address+shared virtual index % stride value). Because the stride value may be accounted for in the calculation of the successive new physical addresses 414, the memory space of the memory 410 allocated to accommodate the privatized output buffer 404 may be compacted to a smaller size than when ignoring the stride value as in FIG. 4B.

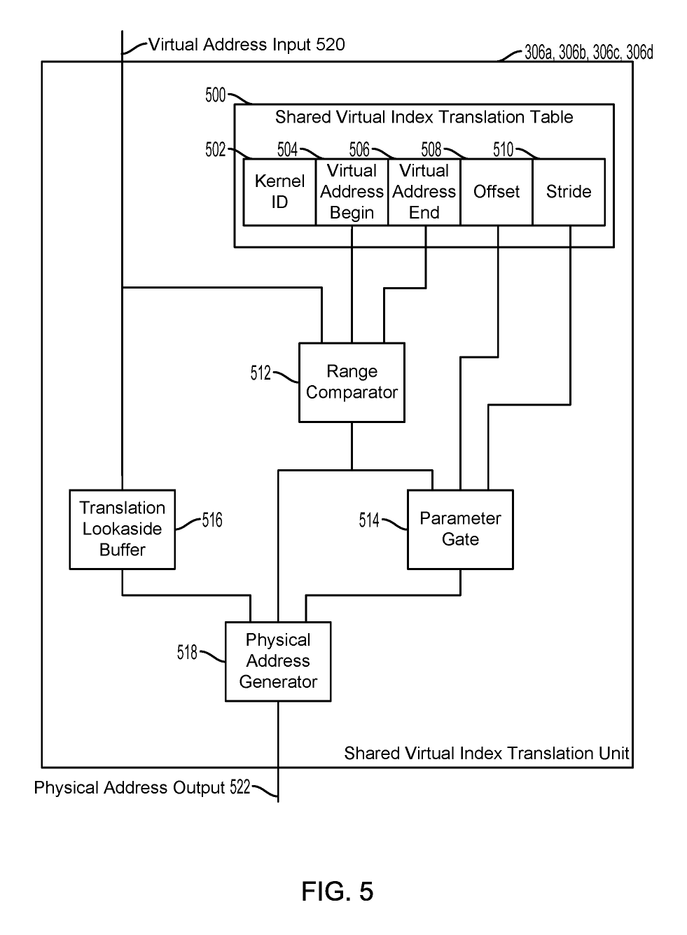

FIG. 5 illustrates an example of a shared virtual index translation unit 306a, 306b, 306c, 306d according to various embodiments. The shared virtual index translation unit 306a, 306b, 306c, 306d may be implemented in hardware, including in dedicated hardware. Alternatively, the shared virtual index translation unit 306a, 306b, 306c, 306d may be implemented in a combination of a processor and/or accelerator (e.g., processor 14 in FIGS. 1 and 2, and CPU 302 and accelerator 312a, 312b, 312c, in FIGS. 3A and 3B) and dedicated hardware, such as a processor executing software within a shared virtual index system that includes other individual components. The shared virtual index translation unit 306a, 306b, 306c, 306d may include a shared virtual index translation table component 500, a range comparator 512, a parameter gate 514, a translation lookaside buffer 516, a physical address generator 518, a virtual address input 520, and a physical address output 522. The shared virtual index translation unit 306a, 306b, 306c, 306d and/or any of its components may be standalone hardware components of a computing device (e.g., computing device 10 in FIG. 1), integrated hardware components of an SoC (e.g., SoC 12 in FIG. 1), integrated hardware components of a processor and/or accelerator, and/or integrated hardware components of a memory manager. Any combination of the components of the shared virtual index translation unit 306a, 306b, 306c, 306d may be communicatively connected to each other.

The shared virtual index translation table component 500 may be a hardware component, such as a memory (e.g., memory 16, 24, in FIG. 1), configured to store shared virtual index information. As discussed herein, the shared virtual index information may include a range of virtual addresses in which an output for a kernel function operating on a portion of application input data may be stored in a privatized output buffer, including a beginning virtual address 504 and an ending virtual address 506 for the range. The shared virtual index information may include an offset 508 for the virtual addresses and/or a stride 510 for the virtual addresses at which the output of the kernel function may be stored in the privatized output buffer. In various embodiments, the shared virtual index information may also include a kernel identifier (ID) 502 to be able to correlate specific shared virtual index information with an outstanding kernel function. The shared virtual index translation table component 500 may store shared virtual index information for each processor/accelerator to which the shared virtual index translation unit 306a, 306b, 306c, 306d may be connected. In various embodiments, the shared virtual index translation table component 500 may also store the shared virtual index information for each outstanding kernel function executed by the processors/accelerators. The shared virtual index translation table component 500 may store the shared virtual index information in a linked or relational manner for each processor/accelerator and/or outstanding kernel.

The range comparator 512 may be a hardware component, such as a combination of logical hardware components, configured to compare a base virtual address for outputting a result of an execution of the kernel function to a privatized output buffer (e.g., privatized output buffer 404 in FIG. 4) to the range of virtual addressed for storing the output to the privatized output buffer. The range comparator 512 may receive the base virtual address from the virtual address input 520. The range comparator 512 may receive or retrieve the virtual address range values, including the beginning virtual address 504 and an ending virtual address 506 for the range of virtual addresses. The range comparator 512 may also receive the base virtual address from the virtual address input 520. The range comparator 512 may compare the base virtual address to the beginning virtual address 504 and an ending virtual address 506 to determine whether the base virtual address falls between the beginning virtual address 504 and an ending virtual address 506. The range comparator 512 may generate different outputs in response to different outcomes of the determination of whether the base virtual address falls between the beginning virtual address 504 and an ending virtual address 506. The range comparator 512 may generate and output an in-range signal in response to determining that the base virtual address is greater than or equal to the beginning virtual address 504 and less than or equal to the ending virtual address 506. The range comparator 512 may generate and output an out-of-range signal in response to determining that the base virtual address is less than the beginning virtual address 504 or greater than the ending virtual address 506. The range comparator outputs may be sent to the parameter gate 514 and the physical address generator 518.

The parameter gate 514 may be a hardware component, such as a logical hardware component, like a multiplexer, configured to control the transmission of the offset 508 and/or the stride 510. The parameter gate 514 may receive the range comparator output and respond to each comparator output differently. The parameter gate 514 may close or remain closed in response to receiving the out-of-range signal from the range comparator 512. In a closed state, the parameter gate 514 may prevent the transmission of the offset 508 and/or the stride 510 from the virtual index translation table component 500 to the physical address generator 518. The parameter gate 514 may open or remain open in response to receiving the in-range signal from the range comparator 512. In an open state, the parameter gate 514 may allow the transmission of the offset 508 and/or the stride 510 from the virtual index translation table component 500 to the physical address generator 518.

The translation lookaside buffer 516 may be a hardware component, such as a memory (e.g., memory 16, 24, in FIG. 1), configured to calculate mapping of the base virtual addresses to physical address of the privatized output buffer (e.g., privatized output buffer 404 in FIGS. 4A-4C). The translation lookaside buffer 516 may also be configured to the receive the base virtual address from the virtual address input 520 and output a corresponding physical address to the physical address generator 518. The translation lookaside buffer may receive the base virtual address, locate mapping information for the base virtual address, and output the associated physical address from the mapping information.

The physical address generator 518 may be a hardware component configured to control the output of the physical address and generate and control the output of a modified physical address. Both of the physical address and the modified physical address may be output from the physical address generator 518 to the physical address output 522 in response to the range comparator output. The physical address generator 518 may output the physical address to the physical address output 522 in response to receiving the out-of-range signal from the range comparator 512. The physical address generator 518 may calculate the modified physical address in response to receiving the in-range signal from the range comparator 512. As discussed herein, the in-range signal from the range comparator 512 may trigger the parameter gate 514 to transmit or pass the offset 508 and/or stride 510 to the physical address generator 518.

The physical address generator 518 may receive the offset 508 and/or stride 510. The physical address generator 518 may be configured to use the physical address received from the translation lookaside buffer 516 and the offset 508, whether or not the stride 510 is received, to calculate the modified physical address, or new base physical address, as described with reference to FIGS. 4A and 4B. The physical address generator 518 may be configured to use the physical address received from the translation lookaside buffer 516 and the offset 508 to calculate the modified physical address, or new base physical address, as described with reference to FIGS. 4A and 4C, and calculate modified physical addresses, or new physical addresses, using the physical address, the index, and the stride 510 as described with reference to FIG. 4C.

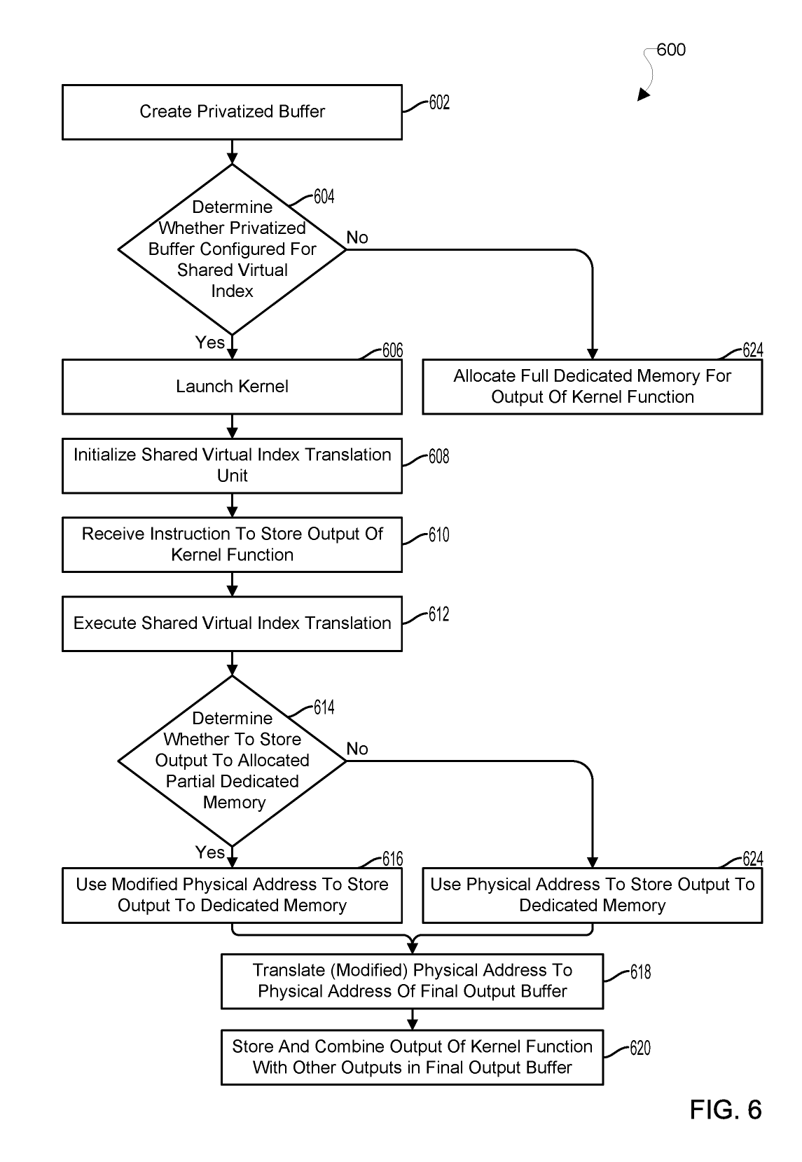

FIG. 6 illustrates a method 600 for shared virtual index translation according to an embodiment. The method 600 may be implemented in a computing device in software executing in a processor (e.g., the processor 14 in FIGS. 1, and 2), in general purpose hardware, in dedicated hardware (e.g., the shared virtual index translation units 306a, 306b, 306c, 306d in FIGS. 3A, 3B, and 5), or in a combination of a processor and dedicated hardware, such as a processor executing software within a shared virtual index system that includes other individual components. In order to encompass the alternative configurations enabled in the various embodiments, the hardware implementing the method 600 is referred to herein as a “processing device.”

In block 602, the processing device may create a privatized output buffer (e.g., privatized output buffer 404 in FIGS. 4A-4C) dedicated for use by a processor/accelerator (e.g., processor 14 in FIGS. 1 and 2, and CPU 302 and accelerator 312a, 312b, 312c in FIGS. 3A and 3B). The processing device may create the privatized output buffer by allocating a portion of a memory (e.g., memory 16, 24, in FIGS. 1 and 2, shared memory 304 and/or dedicated memory 310a, 310b, 310c in FIGS. 3A and 3B, and memory 410 in FIGS. 4A-4C) associated with the processor/accelerator for temporary storage of an output for a kernel function executed by the processor/accelerator. In various embodiments, the privatized output buffer may be configured to support shared virtual index use. The privatized output buffer may indicate support of shared virtual index use by storing a bit at a designated location that may be interpreted as either supporting or not supporting shared virtual index use. The privatized output buffer may be allocated to memory addresses of the memory corresponding to a beginning virtual address and an ending virtual address for the processor/accelerator and/or a kernel. The privatized output buffer may be smaller in size than the full shared and/or dedicated memory used by the processor/allocator. In various embodiments, the privatized output buffer may be sized according to an expected size of an output of an execution of the kernel function executed using a shared virtual index. The size of the privatized output buffer and/or the expected size of the output of the kernel function may correspond to an amount of memory bounded by the beginning virtual address and the ending virtual address.

In determination block 604, the processing device may determine whether the privatized output buffer is configured to support use of a shared virtual index. In various embodiments, the processing device may access a designated location in the privatized output buffer to read an indicator of whether the privatized output buffer supports shared virtual index use.

In response to determining that the privatized output buffer does not support shared virtual index use (i.e., determination block 604=“No”), the processing device may allocate the full shared and/or dedicated memory used by the processor/allocator for the output of the kernel function in block 624.

In response to determining that the privatized output buffer does support shared virtual index use (i.e., determination block 604=“Yes”), the processing device may launch the kernel for a running application in block 606.

In block 608, the processing device may initialize a shared virtual index translation unit (e.g., shared virtual index translation units 306a, 306b, 306c, 306d, in FIGS. 3A and 3B). To initialize the shared virtual index translation unit the processing device may check parameters of the privatized output buffer, the kernel, and the processor/accelerator associated with the privatized output buffer to retrieve the shared virtual index information and store the shared virtual index information in the shared virtual index translation table (e.g., shared virtual index translation table component 500 in FIG. 5). In some embodiments, the processing device may retrieve the beginning virtual address and ending virtual address from the parameters of the privatized output buffer, the offset from the parameters of the processor/accelerator, and the stride value from the parameters of the kernel.

In block 610, the processing device may receive an instruction to store an output of an execution of the kernel function, executed using a shared virtual index. In some embodiments, the processor device may be the processor/accelerator that executes the kernel function using a shared virtual index.

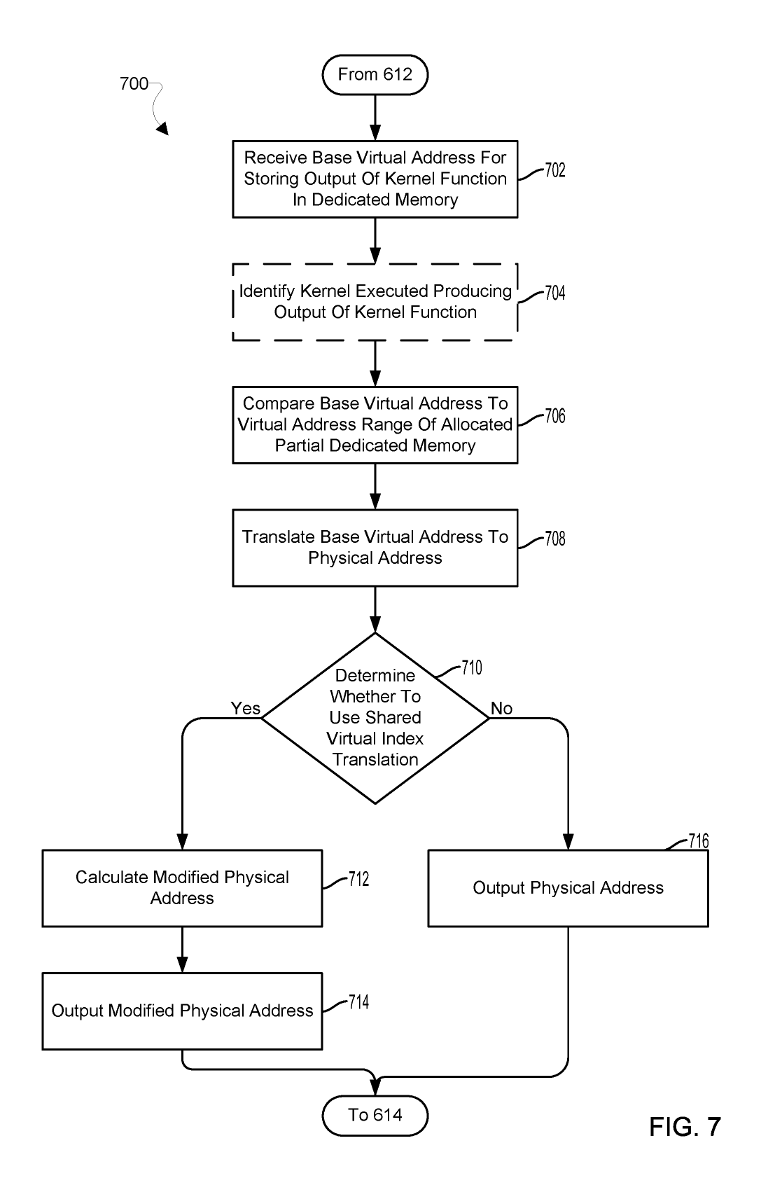

In block 612, the processing device may perform shared virtual index translation as described with reference to the method 700 in FIG. 7.

In determination block 614, the processing device may determine whether to store the output of the execution of the kernel function to the allocated privatized output buffer. Whether to store the output of the execution of the kernel function using the shared virtual index to the allocated privatized output buffer may depend on whether the output from the shared virtual index translation is the physical address or the modified physical address for storing the output to the memory associated with the processor/accelerator. The output of kernel function execution may be stored to the privatized output buffer for an output of the shared virtual index translation being the modified physical address. The output of kernel function execution may be stored to the memory outside of the privatized output buffer for an output of the shared virtual index translation being the physical address.

In response to determining that the output of the execution of the kernel function should be stored to the allocated privatized output buffer (i.e., determination block 614=“Yes”), the processing device may store the output of kernel function execution to the privatized output buffer using the modified physical address in block 616.

In response to determining that the output of the execution of the kernel function should not be stored to the allocated privatized output buffer (i.e., determination block 614=“No”), the processing device may store the output of kernel function execution to the memory outside of the privatized output buffer using the physical address in block 624.

Following storing the output of the execution of the kernel function either to the privatized output buffer in block 616 or to the memory outside of the privatized output buffer in block 624, the processing device may translate the (modified) physical address to a physical address of a final output buffer of a shared memory (e.g., memory 16, 24, in FIG. 1 and shared memory 304 in FIGS. 3A and 3B) in block 618.

In block 620, the processing device may store and combine the output of the kernel function execution in the final output buffer with other outputs of other executions of the same kernel function for different portions of the input data by other processors/accelerators.

FIG. 7 illustrates a method 700 for shared virtual index translation according to an embodiment. The method 700 may be implemented in a computing device in software executing in a processor (e.g., the processor 14 in FIGS. 1, and 2), in general purpose hardware, in dedicated hardware (e.g., the shared virtual index translation units 306a, 306b, 306c, 306d, in FIGS. 3A, 3B, and 5), or in a combination of a processor and dedicated hardware, such as a processor executing software within a shared virtual index system that includes other individual components. In order to encompass the alternative configurations enabled in the various embodiments, the hardware implementing the method 700 is referred to herein as a “processing device.”

In block 702, the processing device may receive the base virtual address for storing the output of the kernel function execution to the memory (e.g., memory 16, 24 in FIGS. 1 and 2, shared memory 304 and/or dedicated memory 310a, 310b, 310c in FIGS. 3A and 3B, and memory 410 in FIGS. 4A-4C), associated with a processor/accelerator (e.g., processor 14 in FIGS. 1 and 2, and CPU 302 and accelerator 312a, 312b, 312c in FIGS. 3A and 3B) that executed the kernel function, for temporary storage of the output of the kernel function. In various embodiments, the processing device may be the processor/accelerator associated with the memory.

In optional block 704, the processing device may identify the kernel executed to produce the output of the kernel function execution. In various embodiments, as described herein, the shared virtual index information may include a kernel identifier (ID) for applications with multiple outstanding kernels. The kernel identifier may be used to locate the appropriate shared virtual index information for the privatized output buffer of the kernel from the shared virtual index translation table (e.g., shared virtual index translation table component 500 in FIG. 5).

In block 706, the processing device may compare the base virtual address with the virtual address range for the privatized output buffer (e.g., privatized output buffer 404 in FIGS. 4A-4C) allocated in the memory for the kernel function execution. As described herein, the virtual address range may include a beginning virtual address and an ending virtual address. The comparison of the base virtual address to the virtual address range may include determining whether the base virtual address is greater than or equal to the beginning virtual adders and less than or equal to the ending virtual address.

In block 706, the processing device may translate the base virtual address to a physical address. The processing device may use a translation lookaside buffer (e.g., translation lookaside buffer 516 in FIG. 5) to translate the base virtual address to its corresponding physical address in the memory. In various embodiments, the translation of the base virtual address to the physical address may occur before, after, or concurrently with blocks 702-710.

In determination block 710, the processing device may determine whether to use shared virtual index translation for the output of the kernel function execution. This determination may be based on the result of the comparison of the base virtual address with the virtual address range for the privatized output buffer in block 706. The base virtual address may be in the virtual address range when the base virtual address is greater than or equal to the beginning virtual adders and less than or equal to the ending virtual address. The base virtual address being in the virtual address range may trigger the determination to use shared virtual index translation for the output of the kernel function execution. The base virtual address may be outside of the virtual address range when the base virtual address is less than the beginning virtual adders or greater than the ending virtual address. The base virtual address being outside the virtual address range may trigger the determination not to use shared virtual index translation for the output of the kernel function execution.

In response to determining that virtual index translation should be used for the output of the kernel function execution (i.e., determination block 710=“Yes”), the processing device may calculate a modified physical address in block 712. The modified physical address may be calculated using the physical address resulting from the translation of the based virtual address in block 708 and shared virtual index information for the kernel execution, including the offset and/or the stride value. Calculating the modified physical address, or new base physical address, may be accomplished using the physical address and the offset, whether or not the stride is available, as discussed herein with reference to FIGS. 4A and 4B. The processing device may also calculate the modified physical address, or new base physical address, as described with reference to FIGS. 4A and 4C, and calculate modified physical addresses, or new physical addresses, using the physical address, the index, and the stride as described with reference to FIG. 4C. In block 714, the processing device may output the modified physical address.

In response to determining that virtual index translation should not be used for the output of the kernel function execution (i.e., determination block 710=“No”), the processing device may output the physical address in block 716.

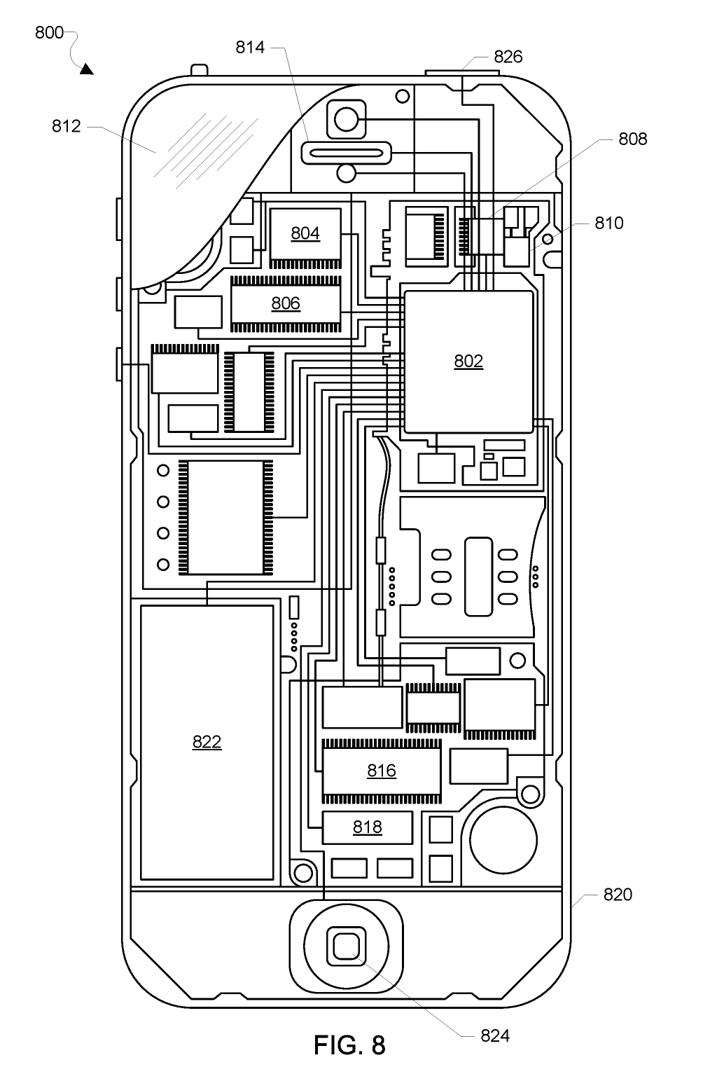

The various embodiments (including, but not limited to, embodiments described above with reference to FIGS. 1-7) may be implemented in a wide variety of computing systems including mobile computing devices, an example of which suitable for use with the various embodiments is illustrated in FIG. 8. The mobile computing device 800 may include a processor 802 coupled to a touchscreen controller 804 and an internal memory 806. The processor 802 may be one or more multicore integrated circuits designated for general or specific processing tasks. The internal memory 806 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the computing device 800 need not have touch screen capability.

The mobile computing device 800 may have one or more radio signal transceivers 808 (e.g., Peanut, Bluetooth, Zigbee, Wi-Fi, RF radio) and antennae 810, for sending and receiving communications, coupled to each other and/or to the processor 802. The transceivers 808 and antennae 810 may be used with the above-mentioned circuitry to implement the various wireless transmission protocol stacks and interfaces. The mobile computing device 800 may include a cellular network wireless modem chip 816 that enables communication via a cellular network and is coupled to the processor.

The mobile computing device 800 may include a peripheral device connection interface 818 coupled to the processor 802. The peripheral device connection interface 818 may be singularly configured to accept one type of connection, or may be configured to accept various types of physical and communication connections, common or proprietary, such as Universal Serial Bus (USB), FireWire, Thunderbolt, or PCIe. The peripheral device connection interface 818 may also be coupled to a similarly configured peripheral device connection port (not shown).

The mobile computing device 800 may also include speakers 814 for providing audio outputs. The mobile computing device 800 may also include a housing 820, constructed of a plastic, metal, or a combination of materials, for containing all or some of the components described herein. The mobile computing device 800 may include a power source 822 coupled to the processor 802, such as a disposable or rechargeable battery. The rechargeable battery may also be coupled to the peripheral device connection port to receive a charging current from a source external to the mobile computing device 800. The mobile computing device 800 may also include a physical button 824 for receiving user inputs. The mobile computing device 800 may also include a power button 826 for turning the mobile computing device 800 on and off.

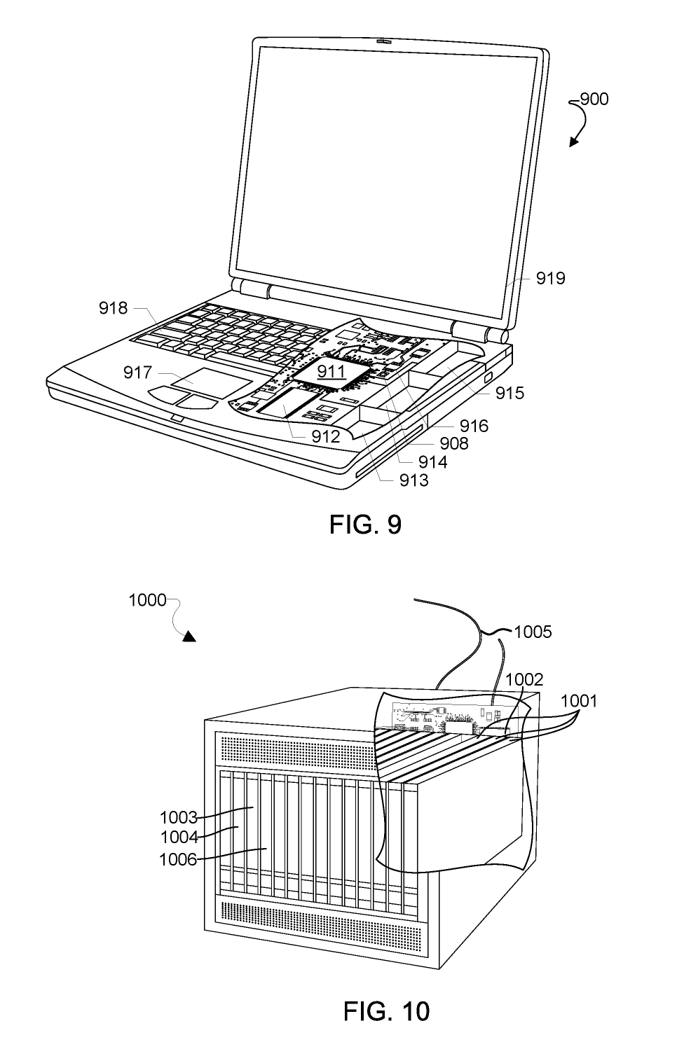

The various embodiments (including, but not limited to, embodiments described above with reference to FIGS. 1-7) may be implemented in a wide variety of computing systems include a laptop computer 900 an example of which is illustrated in FIG. 9. Many laptop computers include a touchpad touch surface 917 that serves as the computer's pointing device, and thus may receive drag, scroll, and flick gestures similar to those implemented on computing devices equipped with a touch screen display and described above. A laptop computer 900 will typically include a processor 911 coupled to volatile memory 912 and a large capacity nonvolatile memory, such as a disk drive 913 of Flash memory. Additionally, the computer 900 may have one or more antenna 908 for sending and receiving electromagnetic radiation that may be connected to a wireless data link and/or cellular telephone transceiver 916 coupled to the processor 911. The computer 900 may also include a floppy disc drive 914 and a compact disc (CD) drive 915 coupled to the processor 911. In a notebook configuration, the computer housing includes the touchpad 917, the keyboard 918, and the display 919 all coupled to the processor 911. Other configurations of the computing device may include a computer mouse or trackball coupled to the processor (e.g., via a USB input) as are well known, which may also be used in conjunction with the various embodiments.

The various embodiments (including, but not limited to, embodiments described above with reference to FIGS. 1-7) may also be implemented in fixed computing systems, such as any of a variety of commercially available servers. An example server 1000 is illustrated in FIG. 10. Such a server 1000 typically includes one or more multi-core processor assemblies 1001 coupled to volatile memory 1002 and a large capacity nonvolatile memory, such as a disk drive 1004. As illustrated in FIG. 10, multi-core processor assemblies 1001 may be added to the server 1000 by inserting them into the racks of the assembly. The server 1000 may also include a floppy disc drive, compact disc (CD) or digital versatile disc (DVD) disc drive 1006 coupled to the processor 1001. The server 1000 may also include network access ports 1003 coupled to the multi-core processor assemblies 1001 for establishing network interface connections with a network 1005, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular. The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of implementing shared virtual index translation on a computing device, comprising:
receiving a base virtual address for storing an output of execution of a kernel function to a dedicated memory;
determining whether the base virtual address is in a range of virtual addresses for a privatized output buffer within the dedicated memory;
calculating a first modified physical address using a physical address mapped to the base virtual address and an offset of a first processing device associated with the dedicated memory in response to determining that the base virtual address is in the range of virtual addresses; and
storing the output of the kernel function execution to the privatized output buffer at the first modified physical address.

2. The method of claim 1, wherein calculating the first modified physical address comprises subtracting the offset from the physical address.

3. The method of claim 1, wherein storing the output of the kernel function execution comprises storing a first portion of the output of the kernel function execution to the privatized output buffer at the first modified physical address, the method further comprising:
calculating a second modified physical address using the physical address mapped to the base virtual address, an index used in executing the kernel function, and a stride value of the kernel function; and
storing a second portion of the output of the kernel function execution to the privatized output buffer at the second modified physical address.

4. The method of claim 3, wherein calculating the second modified physical address comprises adding a result of a modulo operation of the index and the stride value to the physical address.

5. The method of claim 1, wherein the dedicated memory is dedicated for use by the first processing device, the method further comprising:
creating the privatized output buffer in the dedicated memory, the privatized output buffer being smaller in size than the dedicated memory; and
executing, by the first processing device, the kernel function for a first portion of an input data using a shared virtual index that is the same as the shared virtual index used by a second processing device executing the kernel function for a second portion of the input data.

6. The method of claim 1, further comprising:
storing shared virtual index information for the first processing device and the kernel function, wherein the shared virtual index information includes the range of virtual addresses for the privatized output buffer and the offset of the first processing device; and
receiving an instruction to store the output of the kernel function execution at the base virtual address.

7. The method of claim 1, further comprising storing the output of the kernel function execution to the dedicated memory outside of the privatized output buffer at the physical address mapped to the base virtual address in response to determining that the base virtual address is outside of the range of virtual addresses.

8. A computing device, comprising:
a shared virtual index translation unit for implementing shared virtual index translation;
a dedicated memory; and
a first processing device communicatively connected to the shared virtual index translation unit and to the dedicated memory,
wherein the shared virtual index translation unit is configured to perform operations comprising:
receiving a base virtual address for storing an output of execution of a kernel function to the dedicated memory;
determining whether the base virtual address is in a range of virtual addresses for a privatized output buffer within the dedicated memory; and
calculating a first modified physical address using a physical address mapped to the base virtual address and an offset of the first processing device associated with the dedicated memory in response to determining that the base virtual address is in the range of virtual addresses, and
wherein the first processing device is configured with processor-executable instructions to perform operations comprising storing the output of the kernel function execution to the privatized output buffer at the first modified physical address.

9. The computing device of claim 8, wherein the shared virtual index translation unit is configured to perform operations such that calculating a first modified physical address using a physical address mapped to the base virtual address and an offset of a first processing device associated with the dedicated memory comprises subtracting the offset from the physical address.

10. The computing device of claim 8, wherein:
the first processing device is configured with processor-executable instructions to perform operations such that storing the output of the kernel function execution to the privatized output buffer at the first modified physical address comprises storing a first portion of the output of the kernel function execution to the privatized output buffer at the first modified physical address;
the shared virtual index translation unit is configured to perform operations further comprising calculating a second modified physical address using the physical address mapped to the base virtual address, an index used in executing the kernel function, and a stride value of the kernel function; and
the first processing device is configured with processor-executable instructions to perform operations further comprising storing a second portion of the output of the kernel function execution to the privatized output buffer at the second modified physical address.

11. The computing device of claim 10, wherein the shared virtual index translation unit is configured to perform operations such that calculating the second modified physical address comprises adding a result of a modulo operation of the index and the stride value to the physical address.

12. The computing device of claim 8, wherein:
the dedicated memory is dedicated for use by the first processing device; and
the first processing device is configured with processor-executable instructions to perform operations further comprising:
creating the privatized output buffer in the dedicated memory and smaller than the dedicated memory; and
executing the kernel function for a first portion of an input data using a shared virtual index that is the same as the shared virtual index used by a second processing device executing the kernel function for a second portion of the input data.

13. The computing device of claim 8, wherein:
the shared virtual index translation unit is configured to perform operations further comprising storing shared virtual index information for the first processing device and the kernel function;
the shared virtual index information includes the range of virtual addresses for the privatized output buffer and the offset of the first processing device; and
the first processing device is configured with processor-executable instructions to perform operations further comprising receiving an instruction to store the output of the kernel function execution at the base virtual address.

14. The computing device of claim 8, wherein the first processing device is configured with processor-executable instructions to perform operations further comprising storing the output of the kernel function execution to the dedicated memory outside of the privatized output buffer at the physical address mapped to the base virtual address in response to determining that the base virtual address is outside of the range of virtual addresses.

15. A computing device, comprising:
means for receiving a base virtual address for storing an output of execution of a kernel function to a dedicated memory;
means for determining whether the base virtual address is in a range of virtual addresses for a privatized output buffer within the dedicated memory;
means for calculating a first modified physical address using a physical address mapped to the base virtual address and an offset of a first processing device associated with the dedicated memory in response to determining that the base virtual address is in the range of virtual addresses; and
means for storing the output of the kernel function execution to the privatized output buffer at the first modified physical address.

16. The computing device of claim 15, wherein means for calculating a first modified physical address comprises means for subtracting the offset from the physical address.

17. The computing device of claim 15, wherein means for storing the output of the kernel function execution to the privatized output buffer at the first modified physical address comprises means for storing a first portion of the output of the kernel function execution to the privatized output buffer at the first modified physical address, the computing device further comprising:
means for calculating a second modified physical address using the physical address mapped to the base virtual address, an index used in executing the kernel function, and a stride value of the kernel function; and
means for storing a second portion of the output of the kernel function execution to the privatized output buffer at the second modified physical address.

18. The computing device of claim 15, further comprising:
means for creating the privatized output buffer in the dedicated memory and smaller than the dedicated memory; and
means for executing the kernel function for a first portion of an input data using a shared virtual index that is the same as the shared virtual index used by means for executing the kernel function for a second portion of the input data.

19. The computing device of claim 15, further comprising:
means for storing shared virtual index information for the first processing device and the kernel function, wherein the shared virtual index information includes the range of virtual addresses for the privatized output buffer and the offset of the first processing device; and
means for receiving an instruction to store the output of the kernel function execution at the base virtual address.

20. The computing device of claim 15, further comprising means for storing the output of the kernel function execution to the dedicated memory outside of the privatized output buffer at the physical address mapped to the base virtual address in response to determining that the base virtual address is outside of the range of virtual addresses.
